(19) United States
(12) Patent Application Publication
(10) Pub. No.: US 2020/0035179 A1
(43) Pub. Date: Jan. 30, 2020

(54) LIQUID CRYSTAL PANEL INCLUDING GOA CIRCUIT AND DRIVING METHOD THEREOF

(71) Applicant: Shenzhen China Star Optoelectronics Technology Co., Ltd., Shenzhen, Guangdong (CN)

(72) Inventor: Shuai CHEN, Shenzhen (CN)

(73) Assignee: Shenzhen China Star Optoelectronics Technology Co., Ltd., Shenzhen, Guangdong (CN)

(21) Appl. No.: 16/322,036

(22) PCT Filed: Sep. 13, 2018
(86) PCT No.: PCT/CN2018/105435

§ 371 Date: Jan. 30, 2019

(30) Foreign Application Priority Data
Jul. 26, 2018 (CN) 201810832734.4

(51) Int. Cl. G09G 3/36

(52) U.S. Cl. CPC G09G 3/3677; G09G 2310/0294

(57) ABSTRACT

A GOA circuit includes multiple cascade single stage GOA circuit units. Each single stage GOA circuit unit includes a pull-up control circuit unit including a first thin film transistor, wherein a gate and a drain of the first thin film transistor are respectively input with a first clock signal and a scan drive signal, and a source of the first thin film transistor is connected to a precharge node; a pull-up circuit unit including a second thin film transistor, wherein a drain of the second thin film transistor is input with a second clock signal; a pull-down holding circuit unit composed of a Darlington inverter and a third thin film transistor; a pull-down circuit unit for pulling down the electric potentials of the precharge node and the scan drive signal to a low electric potential; and a bootstrap capacitor for holding and increasing the electric potential of the precharge node.

### TECHNICAL FIELD

The present disclosure relates to a technical field of liquid crystal display, more specifically, relates to a liquid crystal panel including a Gate Driver On Array (GOA) circuit and a driving method thereof.

### BACKGROUND ART

A liquid crystal display has advantages of low radiation, small size, low energy consumption and the like, and has been widely used in products such as notebook computers, Personal Digital Assistants (PDAs), flat screen televisions or mobile phones, and the like. An approach of a traditional liquid crystal display is driving a chip on a display panel by using an external driver chip to display images. However, in order to reduce the number of elements and reduce manufacturing costs, in recent years, it has gradually developed to directly manufacturing a driver circuit structure on a display panel, e.g., using a GOA technology.

The GOA technology is to integrate a gate driving circuit of a Thin Film Transistor Liquid Crystal Display (TFT LCD) on a glass substrate to form a scan drive for a liquid crystal panel. Compared with the traditional driving technology using a Chip On Flex/Film (COF), the GOA technology can greatly reduce the manufacturing costs, and the Bonding process of the COF at the Gate side is omitted, which is also very advantageous for improving production capacity. Thus, the GOA is the key technology for the development of the liquid crystal panel in the future.

An existing GOA circuit generally includes a plurality of cascade single stage GOA circuit units, each corresponding to a scan drive line of a corresponding stage. For example, as shown in FIG. 1, the single stage GOA circuit unit includes a pull-up control circuit unit \textcircled{1}, a pull-up circuit unit \textcircled{2}, a signal transfer circuit unit \textcircled{3}, a pull-down circuit unit \textcircled{4}, a pull-down holding circuit unit \textcircled{5}, and a bootstrap capacitor \textcircled{6}. Referring to FIG. 1, the pull-up control circuit unit \textcircled{1} mainly functions to precharge for a precharge node Q(N), and a transfer signal ST(N−1) and a scan drive signal G(N−1) transferred from a previous stage GOA circuit unit are generally input thereto. The pull-up circuit unit \textcircled{2} mainly functions to pull up electric potential of a scan drive signal G(N). The signal transfer unit \textcircled{3} includes a thin film transistor and mainly functions to control turning on and off of the pull-up control circuit unit in a next stage GOA circuit unit by outputting a transfer signal ST(N) of the present stage. The pull-down circuit unit \textcircled{4} mainly functions to pull down the electric potentials of the precharge node Q(N) and the scan drive signal G(N) to a low power supply voltage VSS. The pull-down holding circuit unit \textcircled{5} includes an inverter and a plurality of thin film transistors and mainly functions to hold the electric potentials of the precharge node Q(N) and the scan drive signal G(N) at the low power supply voltage VSS without variation. The bootstrap capacitor \textcircled{6} mainly functions to provide and hold the electric potential of the precharging node Q(N), which is advantageous for the pull-up circuit unit \textcircled{2} to output the scan drive signal G(N).

The inverter of the pull-down holding circuit unit \textcircled{5} may adopt a Darlington inverter, of which the specific circuit structure is as shown in FIG. 2. The Darlington inverter may include four thin film transistors and may have an input terminal Input and an output terminal Output. If a control signal LC is set to always be a high potential signal and the low power supply voltage VSS is set to always be a low potential signal, when the a high potential signal is input to the input terminal Input, the output terminal Output outputs a low potential signal, and when a low potential signal is input to the input terminal Input, the output terminal Output outputs a high potential signal. When the pull-down holding circuit unit \textcircled{5} includes the Darlington inverter, the structure thereof is shown in FIG. 3.

From the perspective of development of the GOA circuit, more and more functional structures are integrated in the cascade units of the GOA circuit. As a result, the GOA circuit structure becomes more and more complex, and also occupies larger space, which is extremely unfavorable for the design of the liquid crystal panel with a narrow bezel.

### SUMMARY

Exemplary embodiments of the present disclosure aim to provide a liquid crystal panel including a GOA circuit and a driving method thereof, wherein the GOA circuit includes a plurality of cascade single stage GOA circuit units, the signal transfer circuit unit is totally omitted in each single stage GOA circuit unit, the circuit structure of a pull-down holding circuit unit is simplified, a control signal of a pull-up control circuit unit is improved so that it can also perform a part of the functions of the pull-down holding circuit unit, the GOA circuit structure is simplified and a narrow bezel design of the liquid crystal panel is realized.

According to an exemplary embodiment of the present disclosure, there is provided a liquid crystal panel including a GOA circuit that includes a plurality of cascade single stage GOA circuit units, wherein each single stage GOA circuit unit includes: a pull-up control circuit unit including a first thin film transistor, wherein a gate of the first thin film transistor is input with a first clock signal, a drain of the first thin film transistor is input with a scan drive signal of a previous stage GOA circuit unit, and a source of the first thin film transistor is connected to a precharge node; a pull-up circuit unit including a second thin film transistor, wherein a drain of the second thin film transistor is input with a second clock signal inverted to the first clock signal; a pull-down holding circuit unit composed of a Darlington inverter and a third thin film transistor; a pull-down circuit unit for pulling down electric potentials of the precharge node and the scan drive signal to a low electric potential; and a bootstrap capacitor for holding and increasing the electric potential of the precharge node.

The single stage GOA circuit unit does not include a signal transfer circuit unit.

In the pull-up circuit unit of each single stage GOA circuit unit, a gate of the second thin film transistor is connected to the precharge node, and a source of the second thin film transistor is connected to a scan drive line of the present stage to output the scan drive signal.

In the pull-down holding circuit unit of each single stage GOA circuit unit, the Darlington inverter has an input terminal and an output terminal, the input terminal is connected to the precharge node and the output terminal is connected to a gate of the third thin film transistor.

In the pull-down holding circuit unit of each single stage GOA circuit unit, a drain of the third thin film transistor is connected to a low power supply voltage line, and a source of the third thin film transistor is connected to the scan drive line of the present stage to output the scan drive signal.

In each single stage GOA circuit unit, the pull-down circuit unit includes a fourth thin film transistor and a fifth thin film transistor, wherein gates of the fourth and fifth thin film transistors are coupled with each other, and both are input with the scan drive signal of a next stage GOA circuit unit; drains of the fourth and fifth thin film transistors are both connected to the low power supply voltage line; and a source of the fourth thin film transistor is connected to the precharge node, and a source of the fifth thin film transistor is connected to the scan drive line of the present stage to output the scan drive signal.

In each single stage GOA circuit unit, one terminal of the bootstrap capacitor is connected to the precharge node, and the other terminal of the bootstrap capacitor is connected to the scan drive line of the present stage.

The first clock signal and the second clock signal are square wave signals which are inverted to each other.

The thin film transistors included in each single stage GOA circuit unit are amorphous silicon thin film transistors which are conductive under high electrical level.

According to the exemplary embodiment of the present disclosure, there is provided a display apparatus including the above liquid crystal panel.

According to the exemplary embodiment of the present disclosure, there is provided a driving method of the liquid crystal panel including the GOA circuit, the liquid crystal panel adopts the aforementioned liquid crystal panel, and the driving method includes: in each single stage GOA circuit unit, during a precharge period, inputting the scan drive signal of the previous stage GOA circuit unit to the precharge node by the pull-up control circuit unit under the control of the first clock signal, to charge the bootstrap capacitor; during an output period, outputting the second clock signal inverted to the first clock signal to the scan drive line of the present stage by the pull-up circuit unit under the control of the electric potential of the precharge node and the bootstrap capacitor to output the scan drive signal; and during a reset period, inputting a low power supply voltage to the precharge node and the scan drive line of the present stage by the pull-down circuit unit under the control of the scan drive signal of the next stage GOA circuit unit to reset the electric potentials of the precharge node and the scan drive signal, wherein during the reset period, the scan drive signal of the previous stage GOA circuit unit is input to the precharge node by the pull-up control circuit unit under the control of the first clock signal to hold the low potential of the precharge node, and the low power supply voltage is input to the scan drive line of the present stage by the pull-down holding circuit unit under the control of the potential of the precharge node to hold the low potential of the scan drive signal.

### BRIEF DESCRIPTION OF THE DRAWINGS

The above and/or other purposes and advantages of the present disclosure will become more apparent from the following description, taken in conjunction with the accompanying drawings in which:

FIG. 1 is a diagram of a single stage GOA circuit unit in the prior art;

FIG. 2 is a circuit diagram of a Darlington inverter included in a pull-down holding circuit unit;

FIG. 3 is a detailed circuit diagram of FIG. 1;

FIG. 4 is an equivalent circuit diagram of a thin film transistor;

FIG. 5 is a circuit diagram of a single stage GOA circuit unit according to an exemplary embodiment of the present disclosure; and

FIG. 6 is a signal oscillogram of the single stage GOA circuit unit of FIG. 5.

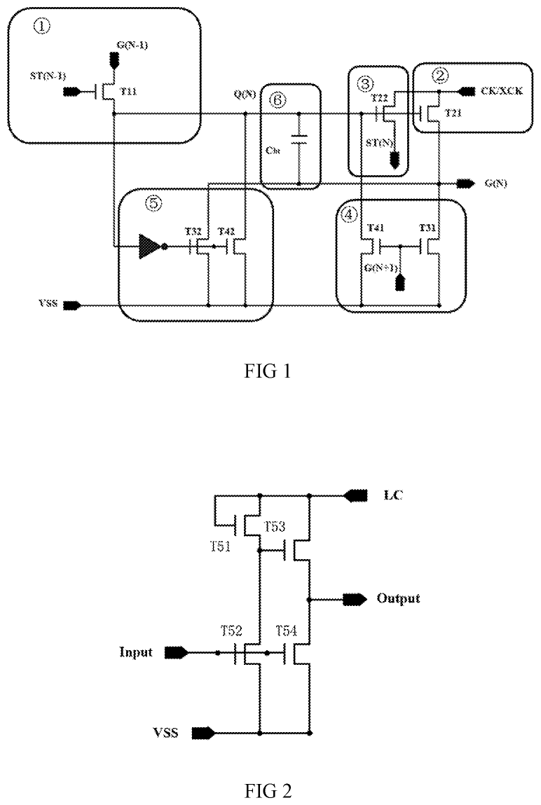

### DETAILED DESCRIPTION OF EXEMPLARY EMBODIMENTS

One or more exemplary embodiments of the present disclosure will be described in more details now by referring to the drawings. The same or corresponding components may be indicated by the same reference numeral and repeated explanations may be omitted.

The terms used herein are only used to describe the exemplary embodiments, and inventive concept is not limited thereto. As used herein, singular forms “a”, “an” and “the” also include plural referents unless the context clearly pointed out otherwise. It will be further understood that when terms “contain” and “include” are used in the description, it reveals the existence of the feature, entirety, step, operation, component, element and/or a group thereof, but it does exclude the presence or addition of one or more other features, entireties, steps, operations, components, elements and/or a combination thereof.

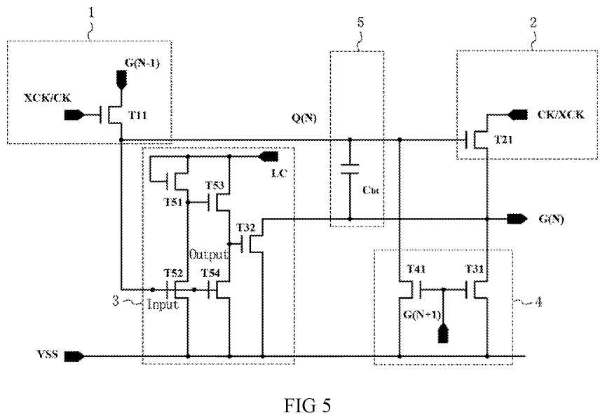

For ease of later understanding, basic elements are described first. A GOA circuit in a liquid crystal panel according to an exemplary embodiment of the present disclosure includes a plurality of thin film transistors. FIG. 4 is an equivalent circuit diagram of a thin film transistor, in which three electrodes of the thin film transistor are Gate, Source and Drain, respectively. And accordingly, voltages applied to respective electrodes may be indicated by Vg, Vs and Vd, respectively. Herein, the Source and the Drain actually have no difference, but for the convenience of description, in the exemplary embodiment, one terminal having a lower voltage is generally referred to as the Source, and the other terminal having a higher voltage is referred to as the Drain. Thus, a voltage Vgs=Vg−Vs, which determines a conducting state of the thin film transistor, and when Vgs>0, the thin film transistor is in the conducting state, a current flows from the Drain to the Source, and when Vgs<0, the transistor is in an off state. Alternatively, in other exemplary embodiments, it is also possible that the terminal having a lower voltage is referred to as the Drain, and the other terminal having a higher voltage is referred to as the Source, that is, when the thin film transistor is in a conducting state, the current flows from the Source to the Drain.

FIG. 5 is a circuit diagram of a single stage GOA circuit unit according to an exemplary embodiment of the present disclosure.

Referring to FIG. 5, the liquid crystal panel according to an exemplary embodiment of the present disclosure includes a GOA circuit that includes a plurality of cascade single stage GOA circuit units, and each single stage GOA circuit unit includes a pull-up control circuit unit 1, a pull-up circuit unit 2, a pull-down holding circuit unit 3, a pull-down circuit unit 4, and a bootstrap capacitor 5. A connection structure of Nth stage GOA circuit unit will be described below as an example, and other stages of GOA circuit units have similar structures.

As shown in FIG. 5, the pull-up control circuit unit 1 in the Nth stage GOA circuit unit includes a first thin film transistor T11, wherein the gate of the first thin film transistor T11 is input with a first clock signal XCK, the drain of the first thin film transistor T11 is input with a scan drive signal G(N−1) of a previous stage (i.e., the (N−1)th stage) GOA circuit unit, and the source of the first thin film transistor T11 is connected to a precharge node Q(N). The pull-up control circuit unit 1 mainly functions to precharge a precharge node Q(N).

As shown in FIG. 5, the pull-up circuit unit 2 includes a second thin film transistor T21, wherein the drain of the second thin film transistor T21 is input with a second clock signal CK which is inverted to the first clock signal XCK. The pull-up circuit unit 2 mainly functions to pull up the electric potential of the scan drive signal G(N).

In the present exemplary embodiment, the gate of the first thin film transistor T11 in the pull-up control circuit unit 1 of the present stage is input with the first clock signal XCK, and the drain of the second thin film transistor T21 in the pull-up control circuit unit 2 of the present stage is input with the second clock signal CK. However, the inventive concept is not limited thereto. According to other exemplary embodiments, the gate of the first thin film transistor T11 in the pull-up control circuit unit 1 of the present stage is input with the second clock signal CK, and the drain of the second thin film transistor T21 of the pull-up control circuit unit 2 of the present stage is input with the first clock signal XCK which is inverted to the second clock signal CK. For ease of description, the exemplary embodiment in which the first thin film transistor T11 is input with the first clock signal XCK while the second thin film transistor T21 is input with the second clock signal CK will be described below in detail.

As shown in FIG. 5, the pull-down holding circuit unit 3 is composed of a Darlington inverter and a third thin film transistor T32. The pull-down holding circuit unit 3 is mainly used for holding the electric potentials of the precharge node Q(N) and the scan drive signal G(N) at the low power supply voltage VSS without variation.

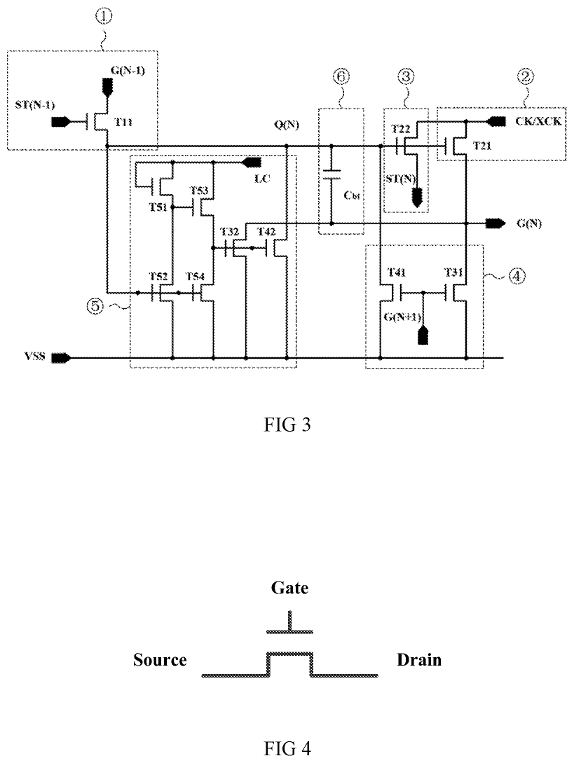

In addition, the single stage GOA circuit unit of the liquid crystal panel according to the present exemplary embodiment further includes a pull-down circuit unit and a bootstrap capacitor. The pull-down circuit unit is used for pulling down the electric potentials of the precharge node and the scan drive signal to a low electric potential. The bootstrap capacitor is used for holding and increasing the electric potential of the precharge node. Compared with the single stage GOA circuit unit in the prior art, the single stage GOA circuit unit included in the liquid crystal panel according to the exemplary embodiment of the present disclosure replaces a transfer signal from the previous stage with a clock signal, and the thin film transistor T42 in the pull-down holding circuit unit \textcircled{5} as shown in FIG. 3 is omitted, thereby simplifying the circuit structure, which is advantageous for realizing a narrow bezel design of the liquid crystal panel.

The structure of the single stage GOA circuit unit included in the liquid crystal panel according to the exemplary embodiment of the present disclosure will be described below in detail by referring to FIG. 5.

Different from the single stage GOA circuit unit as shown in FIG. 3, the single stage GOA circuit unit as shown in FIG. 5 may not include a signal transfer circuit unit. For example, the pull-up circuit unit 2 may only include the second thin film transistor T21. The gate of the second thin film transistor T21 may be connected to the precharge node Q(N). The drain of the second thin film transistor T21 may be input with the second clock signal CK which is inverted to the first clock signal XCK. The source of the thin film transistor T21 may be connected to the scan drive line of the present stage to output the scan drive signal G(N). Since the single stage GOA circuit unit in the liquid crystal panel according to the exemplary embodiment of the present disclosure does not include the signal transfer circuit unit, the single stage GOA circuit unit does not need to transmit the transfer signal to a next stage, and the pull-up control circuit unit of the next stage does not receive the transfer signal from the present stage either, but receives the clock signal in stead of receiving the transfer signal, so that the circuit structure may be further simplified.

In the single stage GOA circuit unit as shown in FIG. 5, the pull-down holding circuit unit 3 may not include the thin film transistor T42, but is only composed of the Darlington inverter and the third thin film transistor T32. For example, the Darlington inverter may have an input terminal Input and an output terminal Output. The gate of the third thin film transistor T32 may be connected to the output terminal Output of the Darlington inverter, the drain thereof may be connected to the low power supply voltage line of the low power supply voltage VSS that outputs a direct current, and the source thereof may be connected to the scan drive line of the present stage to output the scan drive signal G(N).

The Darlington inverter in FIG. 5 may include four thin film transistors T51, T52, T53 and T54, in this case, the gates of the thin film transistors T52 and T54 both may be connected to the input terminal Input, so that both are connected to the precharge node Q(N), the drains of the thin film transistors T52 and T54 both may be connected to the low power supply voltage VSS, the source of the thin film transistor T54 may be connected to the output terminal Output, and the source of the thin film transistor T52 may be connected to the source of the thin film transistor T51 and the gate of the thin film transistor T53; and the thin film transistors T51 and T53 may be connected in series, that is, the drain of the thin film transistor T53 and both of the drain and gate of the thin film transistor T51 may be input with a control signal LC, and the source of the thin film transistor T53 may be connected to the output terminal Output.

In the present exemplary embodiment, assuming that the control signal LC is always a high potential signal and the low power supply voltage VSS is always a low potential signal, when the input terminal Input of the Darlington inverter is input with the high potential signal, the output terminal Output thereof outputs the low potential signal; and when the input terminal Input of the Darlington inverter is input with the low potential signal, the output terminal Output thereof outputs the high potential signal.

As shown in FIG. 5, the pull-down circuit unit 4 may include a fourth thin film transistor T41 and a fifth thin film transistor T31, wherein the gates of the two thin film transistors T31 and T41 may be coupled with each other, and both may be input with the scan drive signal G(N+1) of a next stage (i.e., (N+1)th stage) GOA circuit unit. The drains of the two thin film transistors T31 and T41 both may be connected to the low power supply voltage line, and the source of the fifth thin film transistor T31 may be connected to the scan drive line of the present stage to output the scan drive signal G(N), and the source of the fourth transistor T41 may be connected to the precharge node Q(N).

As shown in FIG. 5, one terminal of the bootstrap capacitor Cbt may be connected to the precharge node Q(N), and the other terminal thereof may be connected to the scan drive line of the present stage. The bootstrap capacitor 5 takes advantage from the characteristic that the voltage across the capacitor cannot abruptly change. When a certain voltage is held across two terminals of the capacitor, the voltage at a negative terminal of the capacitor is increased, and the voltage at a positive terminal still maintains an original voltage difference from the negative terminal, it is equivalent to the case in which the voltage at the positive terminal is raised by the negative terminal. By using this characteristic, the bootstrap capacitor Cbt may hold and increase the electric potential of the precharge node Q(N).

In the exemplary embodiment of the present disclosure, all of the thin film transistors in the GOA circuit may be N-type thin film transistors which are conductive under high electrical level, e.g., N-type amorphous silicon (a-Si) thin film transistors or NMOS thin film transistors which are conducitve under high electrical level. However, the inventive concept is not limited thereto, in other exemplary embodiments, all of the thin film transistors in the GOA circuit may also be P-type thin film transistors that are conductive under low electrical level, e.g., PMOS thin film transistors.

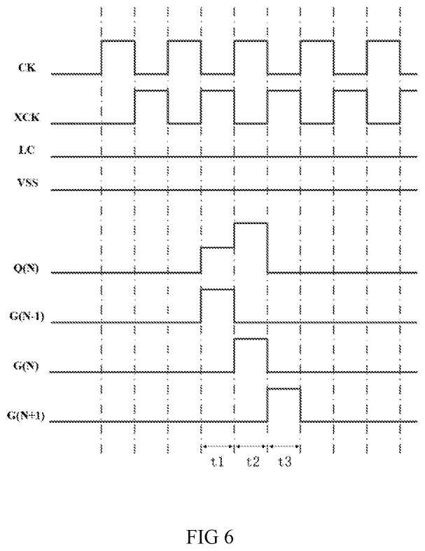

FIG. 6 is a signal oscillogram of the single stage GOA circuit unit of FIG. 5. The driving method of the single stage GOA circuit unit may be described below in detail by referring to FIGS. 5 and 6.

In the present exemplary embodiment, the second clock signal CK may be a square wave signal having a duty ratio (i.e., the ratio of the time duration that the high level occupies in one cycle) of 50%, and may also be a signal having a duty ratio of other values. The second clock signal CK is inverted to the first clock signal XCK. The control signal LC may be the high potential signal, and the low power supply voltage VSS may be the low potential signal.

In the present exemplary embodiment, for ease of description, the embodiment of inputting the second clock signal CK to the drain of the second thin film transistor T21 and inputting the first clock signal XCK to the gate of the first thin film transistor T11 will be described as an example, but the inventive concept is not limited thereto, it is possible to input the first clock signal XCK to the drain of the second thin film transistor T21 and input the second clock signal CK to the first thin film transistor T11. In addition, it is assumed that the thin film transistors included in the Nth stage GOA circuit unit are all N-type thin film transistors having high electrical level conduction.

1. During a Precharge Period t1

In the pull-up control circuit unit 1, since the first clock signal XCK is at a high electric potential, the first thin film transistor T11 is turned on, so that the high electric potential of the scan drive signal G(N−1) of the previous stage (i.e., (N−1)th stage) GOA circuit unit is transmitted to the precharge node Q(N) connected to the source of the first thin film transistor T11, and thus the precharge node Q(N) is charged with the high electric potential, and the bootstrap capacitor Cbt is charged, so as to realize the precharging function.

In the pull-up control circuit unit 2, since the precharge node Q(N) is at the high electric potential, the second thin film transistor T21 is turned on, so that the low electric potential of the second clock signal CK which is inverted to the first clock signal XCK is transmitted to the scan drive line connected to the source of the second thin film transistor T21, that is, the scan drive signal G(N) of low electric potential is output.

In the pull-down holding circuit unit 3, since the precharge node Q(N) is at the high electric potential, that is, the input terminal Input of the Darlington inverter is input with the high electric potential, and the output terminal Output outputs the low electric potential, so that the third thin film transistor T32 is turned off.

2. During a Output Period t2

The first clock signal XCK changes from the high electric potential to the low electric potential, and the second clock signal Ck changes from the low electric potential to the high electric potential. In the pull-up control circuit unit 1, since the first clock signal XCK is at the low electric potential, the first thin film transistor T11 is turned off.

In the pull-up control circuit unit 2, since the precharge node Q(N) is pulled up to a higher electric potential under the effect of the bootstrap capacitor Cbt, the second thin film transistor T21 is still turned on, so that the high electric potential of the second clock signal CK is transmitted from the drain of the second thin film transistor T21 to the scan drive line connected to the source of the second thin film transistor T21, that is, the scan drive signal G(N) of high electric potential is output.

In the pull-down holding circuit unit 3, since the precharge node Q(N) is at the high electric potential, that is, the input terminal Input of the Darlington inverter is input with the high electric potential, and the output terminal Output outputs the low electric potential, so that the third thin film transistor T32 is still turned off.

3. During a Reset Period t3

In the pull-down circuit unit 4, since the scan drive signal G(N+1) of the next stage (i.e., (N+1) stage) GOA circuit unit changes from the low electric potential to the high electric potential, the fifth thin film transistor T31 and the fourth thin film transistor T41 are turned on, the low power supply voltage VSS is transmitted to the precharge node Q(N) of the present stage through the fifth thin film transistor T31, so that the electric potentials of the precharge node Q(N) and the scan drive signal G(N) are pulled down to the low electric potential.

In the pull-up control circuit unit 1, the first clock signal XCK changes from the low electric potential during t2 to the high electric potential again, and the first thin film transistor T11 is turned on. At this time, since the scan drive signal G(N−1) of the previous stage (i.e., (N−1)th stage) GOA circuit unit is at the low electric potential, it is transmitted to the precharge node Q(N) through the first thin film transistor T11, thereby holding the precharge node Q(N) at the low electric potential.

In the pull-up unit 2, since the precharge node Q(N) is at the low electric potential, the second thin film transistor T21 is turned off.

In the pull-down holding circuit unit 3, since the precharge node Q(N) is held at the low the low electric potential, that is, the input terminal Input of the inverter is input with the low electric potential, and the output terminal Output outputs the higher electric potential, so that the third thin film transistor T32 is turned off; and the low power supply voltage VSS is transmitted to the scan drive line of the present stage through the third thin film transistor T32, that is, the scan drive signal G(N) is held at the low electric potential.

To sum up, the present application further provides a driving method forof the liquid crystal panel including the GOA circuit, which may have the circuit structure as shown in FIG. 5, and the driving method of the liquid crystal panel includes: in each single stage GOA circuit unit, during the precharge period t1, the pull-up control circuit unit 1 inputs, during the precharge period t1, the scan drive signal G(N−1) of the previous stage GOA circuit unit to the precharge node Q(N) under the control of the first clock signal XCK, and charges the bootstrap capacitor Ct; the pull-up circuit unit 2 outputs, during the output period t2, second clock signal CK which is inverted to the first clock signal to the scan drive line of the present stage under the control of the electric potential of the precharge node Q(N) and the bootstrap capacitor Ct, so as to output the scan drive signal G(N); and during the reset period t3, the pull-down circuit unit 4, during the reset period t3, inputs a low power supply voltage VSS to the precharge node Q(N) and the scan drive line of the present stage under the control of the scan drive signal G(N+1) of the next stage GOA circuit unit, so as to reset the electric potentials (i.e., pulling down to low electric potentials) of the precharge node Q(N) and the scan drive signal G(N), wherein during the reset period, the pull-up control circuit unit 1 inputs the scan drive signal G(N−1) of the previous stage GOA circuit unit to the precharge node Q(N) under the control of the first clock signal XCK to hold the low potential of the precharge node Q(N), and the pull-down holding circuit unit 3 inputs the low power supply voltage VSS to the scan drive line of the present stage under the control of the potential of the precharge node Q(N) to hold the low potential of the scan drive signal G(N).

It can be seen from the circuit driving method of FIGS. 5 and 6 that, since clock signals CK and XCK are adopted to replace the transfer signal to be transmitted to the pull-up control circuit unit, it may not cause a situation in which the abnormal transferring signals transferring through between stages is abnormal will not occur to when omit the signal transfer circuit in the single stage GOA circuit unit is omitted. Furthermore, although the clock signals CK and XCK periodically jump transist between high and low potentials, in each single stage GOA circuit unit, when the first clock signal XCK is at the high electric potential, the first thin film transistor T11 is turned on, and at this time, the precharge node Q(N) can be pulled up to the high electric potential only when the scan drive signal G(N−1) of the previous stage GOA circuit unit is also at the high electric potential. In addition, when the scan drive signal G(N−1) is at the low electric potential, the precharge node Q(N) may be pulled down to the low electric potential, that is, a part of the functions of the pull-down holding circuit unit is realized. Thus, it may not bring influence on holding the precharge node Q(N) at the low electric potential when the thin film transistor T42 as shown in FIG. 3 in the pull-down holding circuit unit in the single stage GOA circuit unit is omitted.

In conclusion, the present disclosure provides a liquid crystal panel including a GOA circuit and a driving method thereof. The GOA circuit includes a plurality of cascade single stage GOA circuit units, the signal transfer circuit unit is totally omitted in each single stage GOA circuit unit, the circuit structure of a pull-down holding circuit unit is simplified, the control signal of a pull-up control circuit unit is improved so that it can also perform a part of the functions of the pull-down holding circuit unit, thereby reducing the number of the thin film transistors used in the GOA circuit and reducing the number of the signal lines, simplifying the GOA circuit structure and providing new concepts and ideas for the narrow bezel design of the liquid crystal panel in the future.

Furthermore, in addition to the GOA circuit, the liquid crystal panel according to the exemplary embodiment of the present disclosure may further include various common components in the art such as a polarizer, a filter, a liquid crystal layer, and a backlight module, which will not be further described in detail.

The aforementioned contents are examples of the present disclosure and should not be interpreted to confine the present disclosure. Although some embodiments of the present disclosure have been described, those skilled in the art may easily understand that a lot of amendments may made in the embodiments without departing from the features and aspects of the present disclosure. Therefore, all such amendments are intended to be included in the scope of the present disclosure defined by the claims and the equivalents thereof

What is claimed is:

1. A liquid crystal panel comprising a Gate Driver On Array (GOA) circuit that comprises a plurality of cascade single stage GOA circuit units, wherein each single stage GOA circuit unit comprises:
a pull-up control circuit unit comprising a first thin film transistor, wherein a gate of the first thin film transistor is input with a first clock signal, a drain of the first thin film transistor is input with a scan drive signal of a previous stage GOA circuit unit, and a source of the first thin film transistor is connected to a precharge node;
a pull-up circuit unit comprising a second thin film transistor, wherein a drain of the second thin film transistor is input with a second clock signal which is inverted to the first clock signal;
a pull-down holding circuit unit composed of a Darlington inverter and a third thin film transistor;
a pull-down circuit unit for pulling down electric potentials of the precharge node and the scan drive signal to a low electric potential; and
a bootstrap capacitor for holding and increasing the electric potential of the precharge node.

2. The liquid crystal panel of claim 1, wherein each single stage GOA circuit unit does not include a signal transfer circuit unit.

3. The liquid crystal panel of claim 1, wherein in the pull-up circuit unit of each single stage GOA circuit unit, a gate of the second thin film transistor is connected to the precharge node, and a source of the second thin film transistor is connected to a scan drive line of the present stage, to output the scan drive signal.

4. The liquid crystal panel of claim 1, wherein in the pull-down holding circuit unit of each single stage GOA circuit unit, the Darlington inverter has an input terminal and an output terminal, the input terminal is connected to the precharge node and the output terminal is connected to the gate of the third thin film transistor.

5. The liquid crystal panel of claim 4, wherein in the pull-down holding circuit unit of each single stage GOA circuit unit, a drain of the third thin film transistor is connected to a low power supply voltage line, and a source of the third thin film is connected to the scan drive line of the present stage, to output the scan drive signal.

6. The liquid crystal panel of claim 1, wherein in each single stage GOA circuit unit, the pull-down circuit unit comprises a fourth thin film transistor and a fifth thin film transistor, wherein gates of the fourth and fifth thin film transistors are coupled with each other, and both are input with the scan drive signal of a next stage GOA circuit unit; drains of the fourth and fifth thin film transistors are both connected to the low power supply voltage line; and a source of the fourth thin film transistor is connected to the precharge node, and a source of the fifth thin film transistor is connected to the scan drive line of the present stage to output the scan drive signal.

7. The liquid crystal panel of claim 1, wherein in each single stage GOA circuit unit, one terminal of the bootstrap capacitor is connected to the precharge node, and the other terminal of the bootstrap capacitor is connected to the scan drive line of the present stage.

8. The liquid crystal panel of claim 1, wherein the first clock signal and the second clock signal are square wave signals which are inverted to each other.

9. The liquid crystal panel of claim 1, wherein the thin film transistors comprised in each single stage GOA circuit unit are amorphous silicon thin film transistors which are conductive under high electrical level.

10. A driving method of a liquid crystal panel including a GOA circuit, wherein the liquid crystal panel adopts the liquid crystal panel of claim 1, and the driving method comprises:
in each single stage GOA circuit unit,
during a precharge period, inputting, by a pull-up control circuit unit, a scan drive signal of the previous stage GOA circuit unit to a precharge node under the control of a first clock signal, to charge a bootstrap capacitor;
during an output period, outputting, by a pull-up circuit unit, a second clock signal inverted to the first clock signal to a scan drive line of the present stage under the control of an electric potential of the precharge node and the bootstrap capacitor, to output the scan drive signal; and
during a reset period, inputting, by the pull-down circuit unit, a low power supply voltage to the precharge node and the scan drive line of the present stage under the control of the scan drive signal of the next stage GOA circuit unit, to reset the electric potentials of the precharge node and the scan drive signal,
wherein during the reset period, the scan drive signal of the previous stage GOA circuit unit is input to the precharge node by the pull-up control circuit unit under the control of the first clock signal to hold the low potential of the precharge node, and the low power supply voltage is input to the scan drive line of the present stage by the pull-down holding circuit unit under the control of the potential of the precharge node to hold the low potential of the scan drive signal.
